(19) United States
(12) Patent Application Publication
(10) Pub. No.: US 2025/0061155 A1
(43) Pub. Date: Feb. 20, 2025

(54) CONTEXTUAL CONSOLIDATION FROM MULTIPLE SOURCES

(71) Applicant: International Business Machines Corporation, Armonk, NY (US)

(72) Inventors: Shikhar Kwatra, San Jose, CA (US); Jeremy R. Fox, Georgetown, TX (US); Raghuveer Prasad Nagar, Kota (IN); Parvathy Rajeev, Bengaluru (IN)

(73) Assignee: International Business Machines Corporation, Armonk, NY (US)

(21) Appl. No.: 18/235,173

(22) Filed: Aug. 17, 2023

(51) Int. Cl. G06F 16/907; G06F 16/906

(52) U.S. Cl. CPC G06F 16/907; G06F 16/906

(57) ABSTRACT

An embodiment includes loading a plurality of data sources where each data source is comprised of content of interest. The embodiment also includes scanning the plurality of data sources for the content of interest. The embodiment also includes detecting the content of interest from scanning the plurality of data sources where detecting is based on a key word search. The embodiment also includes organizing the content of interest as data elements, based on a topic modeling technique. The embodiment also includes distributing the data elements into a plurality of topics based on a Latent Dirichlet Allocation technique. The embodiment also includes merging the data elements within each of the topics. The embodiment also includes generating a document with the topics into one or more filtered lists, based on the key word search.

### BACKGROUND

The present invention relates generally to data management. More particularly, the present invention relates to a method, system, and computer program for contextual consolidation from multiple sources.

Exploration is finding many ways to reach a solution. Exploring can be done by communicating with peers, getting materials from the knowledge hub, and browsing results, or can be from a book. Each source can be considered as data for analyzing and which further can help for predicting solutions and arriving at solution options.

### SUMMARY

The illustrative embodiments provide for Contextual Consolidation from multiple sources. An embodiment includes loading a plurality of data sources where each data source is comprised of content of interest. The embodiment also includes scanning the plurality of data sources for the content of interest. The embodiment also includes detecting the content of interest from scanning the plurality of data sources where detecting is based on a key word search. The embodiment also includes organizing the content of interest as data elements, based on a topic modeling technique. The embodiment also includes distributing the data elements into a plurality of topics based on a Latent Dirichlet Allocation technique. The embodiment also includes merging the data elements within each of the topics. The embodiment also includes generating a document with the topics into one or more filtered lists, based on the key word search. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of an example contextual consolidation system in accordance with an illustrative embodiment;

FIG. 3 depicts a block diagram of an example consolidation module of a contextual consolidation system in accordance with an illustrative embodiment;

FIG. 4 depicts a flowchart of an example process of contextually consolidating data elements in accordance with an illustrative embodiment; and

FIG. 5 depicts a flowchart of an example process for implementing a contextual consolidation system in accordance with an illustrative embodiment.

### DETAILED DESCRIPTION

Exploration is finding many ways to reach a solution. Exploring can be done by communicating with peers, getting materials from the knowledge hub, and browsing results, or can be from a book. Each source can be considered as data for analyzing and which further can help for predicting solutions and arriving at solution options. When preparing presentations for new tools or equipment users will often start with exploration for information, data, etc. on the target tool or equipment.

When preparing a solution for a client a user may prepare a presentation using a slideshow or other similar document. The slide show allows the user to clearly explain the problems of a current tool, how a new tool replaces or improves the problem, and any advantages of the new tool.

Before preparing the presentation, it is necessary for the user to gather a lot of information including any pros and cons of the new tool and the experience of people who have worked with the new tool. To gather and prepare that information, the user must explore information and data on the internet, communicate with peers who have experience working with the tool, and the user may also need to consult document specific to the tool, such as cheat sheets, that lists steps of using the tools. After the user has received the information, data, etc. for the tool, the user can begin preparing the presentation.

However, the user will face multiple challenges in trying to complete the single task of preparing the presentation. Challenges include, by non-limiting example, the user having to sort through multiple pieces of information in multiple files from different sources. The sources may include emails, web and internet results, training materials, cheat sheets, analyses from peers, and the like. The information that the user receives may be in different formats such as screenshots, images, videos, including tutorial videos, emails, XML files, excel spread sheets, and other forms of electronic files. Another challenge may include the user receiving overlapping and duplicate information. The user will need to be careful not to miss incorporating any information from one source out of multiple sources.

Therefore, there exists a need for a system that can sort through all the information received by the user from multiple sources and merge that information into a usable format for the user to more easily prepare the presentation.

The present disclosure addresses the deficiencies described above by providing a process (as well as a system, method, machine-readable medium, etc.) that contextually consolidates the contents available from multiple sources. The system is derived from content modelling amelioration and deduplication to yield content clarity. Disclosed embodiments combine topic modelling techniques, content merging, and natural language processing techniques (NLP) to produce various types of filtered lists to the user for content topic aligning with the user's original intent. This will allow the user to maintain the focus required for context targeting and focus on the preferred content.

The illustrative embodiments provide for contextual consolidation from multiple sources. A data source as referred to herein is an electronic file or document that includes information that may be of interest to the user when exploring content for a new presentation; however, use of this example is not intended to be limiting but is instead used for descriptive purposes only. Instead, the data source can include emails, transcripts of voice records, images such as screenshots, JPEG files, as well as others.

Also, a data element referred to herein may be a portion of a data source that is specific to the topic that the user has identified as exploring. A data element may be identified based on a key word. The key word may be identified by the user. In various embodiments, the key word may be determined by the system.

Illustrative embodiments include loading a plurality of data sources where each data source includes content of interest to the user. The illustrative embodiment may also include scanning the plurality of data sources for the content of interest. In various embodiments, the data sources may include by non-limiting example, emails, web and internet results, training materials, cheat sheets, analyses from peers, screenshots, images, videos, including tutorial videos, emails, XML files, excel spread sheets, and other forms of electronic files. The illustrative embodiment may also include detecting the content of interest from scanning the plurality of data sources. Detecting may be based on a key word search. The key word may be defined by a user or determined by the system.

The data sources may be defined by the location of the data or by the content of the data. The system may contextually consolidate the contents available from multiple sources where context is derived based on communication, calendar, content-activity, and content location. By non-limiting example of consolidating based on communication, a user may send an email to colleagues asking for their experience on a tool that the user is researching. The user wants to consolidate the experiences and present the experiences to the management. The system will start monitoring and consolidating the responses to the email. By non-limiting example of consolidating based on a calendar, a user has a meeting with leadership where the agenda includes presenting the experiences the user's team had with a recently launched tool. The system will start monitoring inbound communications over email, Slack, and similar applications. The system may also start creating an electronic slide show presentation which will include the experiences shared with the user. By non-limiting example of consolidating content-activity, a user may start creating a document titled “Experiences with the Tool.” The system will determine that the user is preparing the document to summarize the experiences people had with the tool by scanning the beginning or introduction of the document. In other embodiments, the system may collect experience data from communications and intranet and will then add to the document created by the user. By non-limiting example of consolidating content-locations, a user may want to prepare a design document template. The user started collecting design templates from colleagues and the internet. The user stored all the templates in a folder called “samples.” The system may create a new file called “Potential Design Templates” by merging all the templates available in the folder created by the user. The system may keep revising the “Potential DesignTemplate” file as new files are added to the folder.

The system may also contextually consolidate the contents available from multiple sources where content sources can be a file, a communication, a website from the internet, or a database. By non-limiting example, a user may be preparing a design document for order scheduling. The user may receive an email with design considerations for the API to be exposed. The user may have scheduled a meeting with the team and the team prepared a JPEG diagram depicting scheduling flow and the same diagram is stored in another file sharing program. When the user creates a document with a name “OrderScheduling-Design” based on the design template and then works on the document, the system is triggered to begin consolidating. The system may present a prompt on the user's AR glass asking the user is the system should copy the email contents and the image in the document. The system may also project previews of the email and the image on a portion of the user's AR glass. The user may approve the system's request by a voice command. Once approved, the system may start copying the image and the email to the document “OrderScheduling-Design.” The user is able to see the data sources moving to the design document. To efficiently use the storage, the system may further check with the user to ask if the image can be purged once it is copied into the design document.

The system may also consolidate the contents available from multiple data sources based on a policy of a business or organization. The system may also consolidate based on user preferences. By non-limiting example, a user may prepare a proposal to a client which involves implementing a new tool in the environment. The user explores the internet for the pros and cons of the tool and communicates with peers who have worked on the tool. The user downloads 2 images from internet and receives a few responses. When the user starts preparing the presentation, the system may copy the images to a document and label the document “Source: Internet” as the caption for both the images because a policy of the organization requires internet content to be declared. The system may also extract relevant information from the emails the user received and copy only the extracted information to the document. In various embodiments, the document may be a PowerPoint slide presentation. In other embodiments, other applications may be used. In a similar example, the system may use URLs of the images and copy those into the document instead of the images themselves because the user prefers to refer to files rather than using copies.

Illustrative embodiments include organizing the content of interest as data elements based on a topic modeling technique. Topic modelling will be conducted to secure the various types of data relevance required to ensure that various pieces of content are gathered and assimilated properly. Topic models are a type of statistical language models used for uncovering hidden structure in a collection of texts. The system may reduce dimensionality using an algorithm. In various embodiments, the algorithm may be Uniform Manifold Approximation and Projection (UMAP). UMAP is a dimension reduction technique that can be used for visualization and for general non-linear dimension reduction. Topic modeling may also include unsupervised learning. Unsupervised learning which will build clusters of words rather than clusters of texts. A text as referred to herein is a mixture of all topics where each topic has a specific weight.

Illustrative embodiments also include distributing the data elements into a plurality of topics based on a Latent Dirichlet Allocation (LDA) technique. The LDA technique is a topic modeling algorithm. The LDA technique includes loading data, cleaning the data, performing an exploratory analysis, preparing the data for an LDA analysis, LDA model training, and analyzing the LDA model results. The LDA process will ensure that the topics are correlated properly across various data sources.

Illustrative embodiments also include merging the data elements within each of the topics. The merged data elements may be transformed. For example, when a user may be preparing a proposal to the client for a new tool, the user may download two images from the internet. The first image may be a screenshot of the steps to use the tool and the second image may depict the components involved in the tool. When the user starts preparing the presentation, the system may copy the images to the presentation and also prepare text for the steps mentioned in the first image. The system may extract the text in the first image.

Illustrative embodiments also include generating a document with the plurality topics extracted through topic modeling. For example, a user is preparing a design document template along with a design guideline document. The user collected design templates and guidelines from colleagues and internet. The user kept all collected templates and guidelines in a folder. The system will create a new presentation file called “PotentialDesignTemplate” by merging all the templates available in the folder created by the user. The system may also create a new Word processing file called “PotentialDesignGuidelines” by merging all available guidelines in the folder.

Illustrative embodiments also include refining the data for correctness, completeness, and relevance. The system may classify data elements in the plurality of topics as duplicates or similar. The system may delete the duplicated elements within each of the topics. For example, a user preparing a proposal to the client which involves implementing a new tool in the environment may communicate with peers who have worked on the tool. The user may receive three responses. The first response may mention that the writer has no experience with the tool. The second email may mention that certain applications should be closed while running the tool. The third email may mention that tool should be run with higher memory allocated to it if other applications are running on the system. The system may ignore first email because it is not relevant. The system may also ignore the second email because it contains information that is similar to the third email. The third email may be considered more complete than the second email because it covers the information in the second email.

Illustrative embodiments also include deleting source content that has been completely consolidated. To efficiently use storage, the system may verify with the user if data sources can be deleted once the system has consolidated the information into documents.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

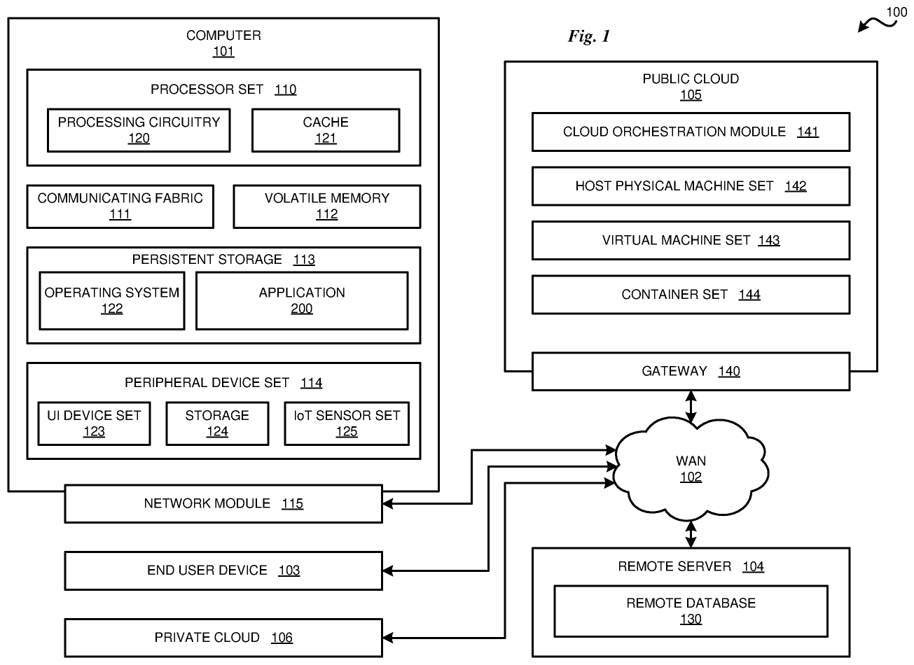

With reference to FIG. 1, this figure depicts a block diagram of a computing environment 100. Computing environment 100 contains an example of an environment for the execution of at least some of the computer code involved in performing the inventive methods, such as an application 200 contextually consolidates content of data sources based on cognitive content modeling amelioration and deduplication. The system may use artificial intelligence (AI), augmented reality (AR), and the internet of things (IoT) to contextually consolidate data sources. In addition to application 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and application 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored application 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in application 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

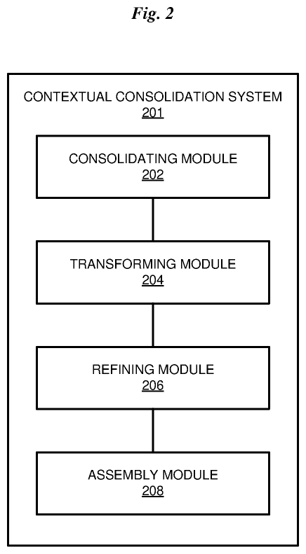

With reference to FIG. 2, this figure depicts a block diagram of an example contextual consolidation system 201 in accordance with an illustrative embodiment in accordance with an illustrative embodiment. In the illustrated embodiment, the contextual consolidation system 201 includes the application 200 of FIG. 1.

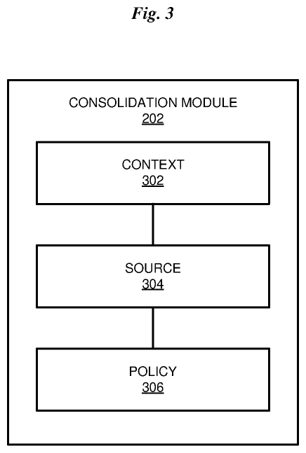

In the illustrated embodiment, the contextual consolidation system 201 contextually consolidates the contents available from multiple sources derived from content modelling amelioration and deduplication to yield content clarity. The system includes a consolidation module 202 which scans a plurality of data sources loaded into the system. As illustrated in FIG. 3, the consolidation module can consolidate data based on context 302, the source 304 of the data, or the policy 306 of a company or preferences of a user. The system also includes a transformation module 204. The transformation module 204 can take the content from the data sources and transform the content into different formats. For example, the system can take an image with text and extract the text to put into a word processing document.

As illustrated, the contextual consolidation system 201 includes a refining module 206. The refining module takes the consolidated content and refines for correctness, completeness, and relevance. For example, as previously described, if there are duplicates data elements in multiple data sources the system will delete a data source that duplicates another source. The system may choose the data source that includes more information or is more recent. More recent as referred herein means that the data source was written at a time that is closer to the time the system is refining. The system may also note a discrepancy in one data source over another data source and may verify with data source is correct and delete the other data source. Verifying which data set is correct may include, by non-limiting example, notifying the user of the discrepancy and asking the user to choose which is correct.

As illustrated, the contextual consolidation system 201 also includes an assembly module 208. The assembly module 208 may generate a document with the plurality of topics. The assembly module may merge similar data elements within each of the topics and assimilate the topics into one or more filtered lists. The lists may be based on unique key word search criteria. The system will produce various types of filtered lists for the user for content topics. The lists may align with the user's original intent. This will allow the user to maintain the focus required for context targeting and focus the user on the preferred content.

With reference to FIG. 3, this figure depicts a block diagram of an exemplary consolidation module 202 of a contextual consolidation system 201 in accordance with an illustrative embodiment. In the illustrated embodiment, the contextual consolidation system 201 is an example of the application 200 of FIG. 1.

In the illustrated embodiment, the consolidation module 202 receives a plurality of data sources wherein each data source is comprised of content. In the context module 302, the consolidation module 202 may consolidate the contents available from multiple sources where context is derived based on communication, calendar, content-activity, and content location. For example, a user sends an email to his colleagues asking for their experience on the tool so that he can consolidate the experiences and present the same to the management. The system will start to monitor and consolidate the responses to the email. As a non-limiting example of consolidating by calendar, the user has a meeting with leadership where the agenda includes the user presenting the experiences his team had with the recently launched tool. The system will start to monitor inbound communications over, by non-limiting example, email, instant messaging programs and other similar communication devices and applications used within the organization. As an example of content-activity, the user may start creating a slide show presentation with the title “Experience with the Tool.” Based on the contents of first slide or introduction slide, the system may determine that the user is preparing the presentation to summarize the experiences people had with the tool. The system will then collect experience data from communications and intranet and then add new slides summarizing the data. As an example of content location, a user may want to prepare a design document template. As part of his exploration, the user has started collecting design templates from colleagues and the internet. He keeps all collected templates in a folder called “Samples”. The system may create a new file called “PotentialDesignTemplate” by merging all the templates available in the folder. The system may continue to revise the “PotentialDesignTemplate” file as soon as a file is added to the folder.

In the source module 304, the consolidation module 202 may consolidate the contents available from multiple sources where content sources can be file, communication, internet, or a database. For example, a user may prepare a design document for order scheduling. The user receives an email explaining the design considerations for the API to be exposed. The user had scheduled a meeting with the team where the team prepared a JPEG diagram depicting scheduling flow and the same is available at a cloud-based document storage program. As soon as the user creates a document with the name “OrderScheduling-Design” based on design template and then starts working on it, the system is triggered. The system presents a prompt on the users AR glass asking if system should copy the email contents and the image in the document, with previews of the email and the image displayed on the top right-hand side of the glass. On voice approval from the user, system starts copying and the user, on his AR glass, sees the emails moving to the design document. To efficiently use the storage, the system further checks with the user if the image can be purged from the cloud-based document storage because it is now available in the design document.

In the policy module 306, the consolidation module 202 may consolidate the contents available from multiple sources where consolidation is done based on the organization policy and user preferences. As an example of the system following an organization policy, a user is preparing a proposal to a client which involves implementing a new tool in the environment. The user explores the internet for the pros and cons of the tool and communicates with her peers who have worked on the tool. The user downloads two images from the internet and receives a few responses. When the user starts preparing the presentation, the system copies the images to the presentation and adds the caption “Source: Internet” for both the images because the organization policy requires internet content to be declared. The system extracts relevant information from the emails the user received and copies only the extracted information to the presentation.

The system can also learn and follow preferences of a user. For example, a user is preparing a proposal to a client which involves implementing a new tool in the environment. The user explores the internet for the pros and cons of the tool and communicates with her peers who have worked on the tool. The user downloads two images from internet and receives a few responses. When the user starts preparing the presentation, the system does not copy the images and instead uses URLs of the images in the presentation because the user prefers to refer to existing files rather than making copies of the images.

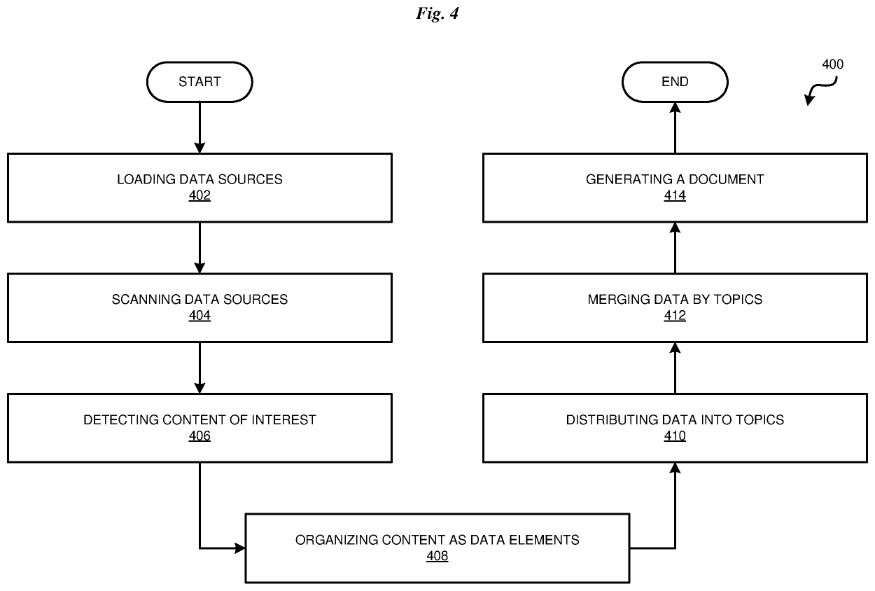

With reference to FIG. 4, this figure depicts a flowchart of an example process 400 of contextually consolidating data elements in accordance with an illustrative embodiment.

The system loads data sources 402 where each data source includes content of interest to the user. The user chooses a topic for the content of interest. The system may load the data sources through consolidating based on content such as, by non-limiting example, communication, calendar, content-activity, content location. The data sources may also be consolidated based on sources such as, by non-limiting example, file, communication, internet, or a database. The system may also load the data sources through consolidating content based on an organization policy or user preferences. The process also includes scanning 404 data sources for the content of interest. The process also includes detecting the content of interest 406 from scanning the plurality of data sources. Detecting may be based on a key word search. One or more key word may be used for the search criteria.

The process also includes organizing the content of interest as data elements. The content may be based on a topic modeling technique. In Natural Language Processing (NLP), topic models are a type of statistical language models used for uncovering hidden structure in a collection of texts. Topic modelling will be conducted in order to secure the various types of data relevance required to ensure that various pieces of content are gathered and assimilated properly. Topic modeling techniques may include dimensionality reduction, unsupervised learning, and tagging. The process this invention uses is described within for topic modelling. Dimensionality reduction includes representing a text T as {Topic_i: Weight(Topic_i, T) for Topic_i in Topics} instead of {Word_i: count(Word_i, T) for Word_i in Vocabulary}. In various embodiments, the dimensionality reduction algorithm may include Uniform Manifold Approximation and Projection (UMAP). UMAP keeps a large portion of the high-dimensional local structure in lower dimensionality. Unsupervised learning is similar to clustering where the clusters are made of words rather than clusters of texts. A text is then a mixture of all the topics with each topic having a specific weight. Tagging includes grouping abstract topics that occur in a collection of documents that best represents the information in the documents.

The process also includes distributing data into topics 410. The data elements are distributed into a plurality of topics based on the Latent Dirichlet Allocation (LDA) technique. LDA is a topic modeling algorithm used to identify latent topics in a text and represent documents as a mixture of topics. LDA is a generative probabilistic model of a corpus. Documents are represented as random mixtures over latent topics, where each topic is characterized by a distribution over words. Performing an LDA would include loading data, data cleaning, exploratory analysis, preparing data for LDA analysis, LDA model training, and analyzing LDA model results.

The process also includes merging data by topics 412. Similar data elements will be merged within each of the topics. The system will also allow for non-use of the potential topics that are marked above for reduction of duplication. The process also includes reducing duplicate data elements within each of the topics.

The process also includes generating a document. The system will generate a document with the topics into one or more filtered lists. The topics will be based on the key word search. The system will produce various types of filtered list(s) for the user for content topics. The lists will align the user's original intent. This will allow the user to maintain the focus required for their context targeting and focus them on the preferred content.

The system also includes content merging with Bidirectional Encoder Representations from Transformers (BERT). BERT is an open-source machine learning framework for NLP. Interleaving text at the right portions involves timestamping and sequencing the content to form the content lineage (content lineage is enabling art). The information is juxtaposed to each other based on timeline and similarity analysis conducted removes duplicated content which is clustered using sentence-transformers package as the resulting embeddings have shown to be of high quality and typically work quite well for document-level embeddings. HDBSCAN is a density-based algorithm for clustering similar content that works quite well with UMAP since UMAP maintains a lot of local structure even in lower-dimensional space. Once that is done, class-based variant of TF-IDF (c-TF-IDF), would allow to extract what makes each set of documents unique compared to the other.

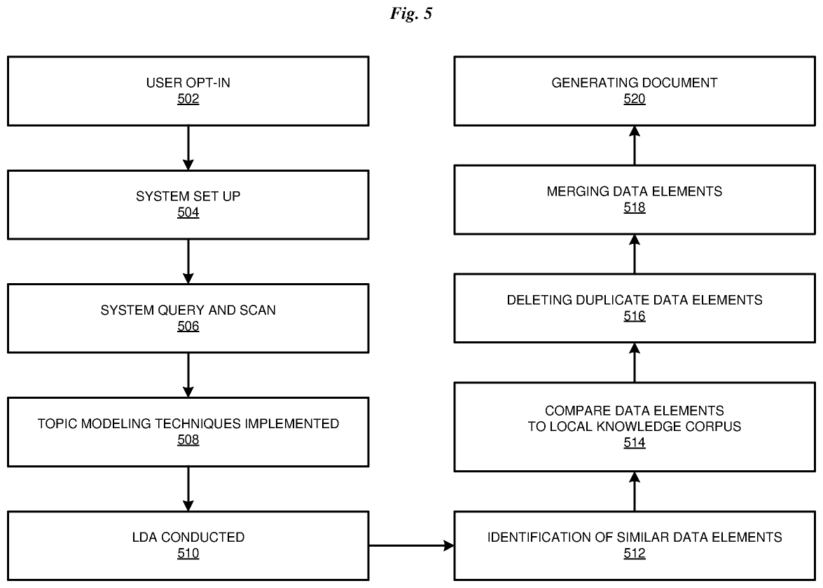

With reference to FIG. 5, this figure depicts a flowchart of an example process for implementing 500 a contextual consolidation system 201 in accordance with an illustrative embodiment. The contextual consolidation system 201 may be run as an application 200 in FIG. 1.

The system requires a user to opt-in 502 for the system 201 to be successfully implemented. The User needs to allow the system to track various types of data, accounts, and a wholistic approach to data management in general. The user will need to Opt-in to the following items pertinent to privacy allowance including data collection, data investigation, local device file inquiries, calendar and communications, various databases including published, private, and hybrid databased; and internet access to access pages and downloadable content.

As illustrated, implementation of the system also includes system set-up 504 and data privacy allowance. The system may need to be set up for each individual user that pertains to their personal accounts, communications mediums, OS level access against various applications and file level access.

As illustrated, implementation of the system includes system query and scan 506. Scanning for content with unique key word searching criteria will be the primary means of content and data acquisition by the system. Topic modelling will be conducted in order to secure the various types of data relevance required to ensure that various pieces of content are gathered and assimilated properly.

As illustrated implementation of the system includes the topic modelling techniques being implemented 508. Once the content has been identified, the system will begin to organize the content through topic modelling techniques.

As illustrated, the algorithm used to implement the topic modeling in the system is Latent Dirichlet Allocation (LDA) 510. The LDA technique is a topic modeling algorithm. The following steps will be utilized for conducting an LDA: loading data; data cleaning; exploratory analysis; preparing data for LDA analysis; LDA model training; and analyzing LDA model results. Running the LDA model will include gathering the output of the LDA process after it has been run across various communication, files, materials, data, and other personal content that is processed.

Once the LDA algorithm is run, the system will identify similar data elements 512. The data elements can be correlated and marked with particular identification labels that are relevant to the users' topics as required.

The system will then compare data elements to a local or known knowledge corpus 514. Comparing data elements to a managed knowledge corpus on a local device will allow for the topics to be identified against various local topics and data elements. In various embodiments, one or more local devices may be used for the comparison.

As illustrated, implementation of the process includes deleting duplicate data elements 516. For the defined duplication of local repetitive data elements, the system will identify content as being duplication of other said content and then derive which element is the authority on the data source. The data source can be determined by content timestamping, content usage patterns, hits, or content interaction from the system to the defined user. In various implementations, multiple content interactions may be scanned to determine and delete duplication.

As illustrated, the process includes merging data elements 518. The system will merge topics that are similar and allow for non-use of the potential topics that are marked above for reduction of duplication.

As illustrated, the process includes generating a document with the topics organized from the topic modeling technique. The system will produce various types of filtered lists for the user for content topics. The topics may align the user's original intent. This process will allow the user to maintain the focus required for their context targeting and focus them on the preferred content.

The system also includes content merging with Bidirectional Encoder Representations from Transformers (BERT). Interleaving text at the right portions involves timestamping and sequencing the content to form the content lineage. The information is juxtaposed to each other based on timeline and similarity analysis conducted removes duplicated content which is clustered using sentence-transformers package as the resulting embeddings have shown to be of high quality and typically work quite well for document-level embeddings. HDBSCAN is a density-based algorithm for clustering similar content that works quite well with UMAP since UMAP maintains a lot of local structure even in lower-dimensional space. Once that is done, class-based variant of TF-IDF (c-TF-IDF), would allow to extract what makes each set of documents unique compared to the other.

A computer implemented method, computer system and a computer program product for contextual consolidation of content of data sources based on cognitive content modeling amelioration and deduplication: Providing a plurality of data sources wherein each data source is comprised of content; Scanning plurality of data sources for content; Identifying the content of interest from scanning the plurality of data sources, wherein identifying is based on one or more unique key word search criteria. Organizing the identified content as data elements, based on one or more topic modeling techniques, wherein the topic modeling technique comprises dimensionality reduction (e.g., UMAP), unsupervised learning (e.g., Clustering algorithm) and tagging (i.e., Topics); Allocating the data elements into a plurality of topics based on a Latent Dirichlet Allocation; Classifying one or more data elements within one of the plurality of topics as duplicate or similar based on the Latent Dirichlet Allocation Reduction of duplicate data elements within the each of the topics; Merging of similar data elements within each of the topics; Assimilating the topics into one or more filtered lists, based on the unique key word search criteria.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (Saas) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
loading a plurality of data sources wherein each data source is comprised of content of interest;
scanning the plurality of data sources for the content of interest;
detecting the content of interest from scanning the plurality of data sources, wherein detecting is based on a key word search;
organizing the content of interest as data elements, based on a topic modeling technique;
distributing the data elements into a plurality of topics using a topic modeling algorithm;
merging the data elements within each of the plurality of topics; and
generating a document with the topics into one or more filtered lists, based on the key word search.

2. The computer-implemented method of claim 1, further comprising:
classifying one or more data elements within one of the plurality of topics as duplicate; and
deleting duplicate data elements within the each of the topics.

3. The computer-implemented method of claim 1, wherein the topic modeling algorithm comprises Latent Dirichlet Allocation (LDA).

4. The computer-implemented method of claim 1, wherein the data sources are consolidated based on a context.

5. The computer-implemented method of claim 1, wherein the data sources are consolidated based on a source.

6. The computer-implemented method of claim 1, further comprising a user choosing a topic of the content of interest.

7. The computer-implemented method of claim 1, wherein the topic modeling technique comprises dimensionality reduction.

8. The computer-implemented method of claim 1, wherein the topic modeling technique comprises unsupervised learning.

9. The computer-implemented method of claim 1, wherein the topic modeling technique comprises tagging.

10. A computer program product comprising one or more computer readable storage device, and program instructions collectively stored on the one or more computer readable storage device, the program instructions executable by a processor to cause the processor to perform operations comprising:
loading a plurality of data sources wherein each data source is comprised of content of interest;
scanning the plurality of data sources for the content of interest;
detecting the content of interest from scanning the plurality of data sources, wherein detecting is based on a key word search;
organizing the content of interest as data elements, based on a topic modeling technique;
distributing the data elements into a plurality of topics using a topic modeling algorithm;
merging the data elements within each of the plurality of topics; and
generating a document with the topics into one or more filtered lists, based on the key word search.

11. The computer program product of claim 10, wherein the stored program instructions are stored in the computer readable storage device in a data processing system, and wherein the stored program instructions are transferred over a network from a remote data processing system.

12. The computer program product of claim 10, wherein the stored program instructions are stored in the computer readable storage device in a server data processing system, and wherein a stored program instructions are downloaded in response to a request over a network to a remote data processing system for use in the computer readable storage device associated with the remote data processing system, further comprising:
program instructions to classify one or more data elements within one of the plurality of topics as duplicate; and
program instructions to delete duplicate data elements within the each of the topics.

13. The computer program product of claim 10, wherein the topic modeling algorithm comprises Latent Dirichlet Allocation (LDA).

14. The computer program product claim 10, wherein the topic modeling technique comprises dimensionality reduction.

15. The computer program product claim 10, wherein the topic modeling technique comprises tagging.

16. The computer program product claim 10, wherein the topic modeling technique comprises unsupervised learning.

17. A computer system comprising a processor and one or more computer readable storage device, and program instructions collectively stored on the one or more computer readable storage device, the program instructions executable by the processor to cause the processor to perform operations comprising:
loading a plurality of data sources wherein each data source is comprised of content of interest;
scanning the plurality of data sources for the content of interest;
detecting the content of interest from scanning the plurality of data sources, wherein detecting is based on a key word search;
organizing the content of interest as data elements, based on a topic modeling technique;
distributing the data elements into a plurality of topics using a topic modeling algorithm;
merging the data elements within each of the plurality of topics; and
generating a document with the topics into one or more filtered lists, based on the key word search.

18. The computer system of claim 17, wherein the topic modeling algorithm comprises Latent Dirichlet Allocation (LDA).

19. The computer system of claim 17, wherein the topic modeling technique comprises dimensionality reduction.

20. The computer system of claim 17, further comprising:
classifying one or more data elements within one of the plurality of topics as duplicate; and
deleting duplicate data elements within the each of the topics.
